(19) United States
(12) Patent Application Publication
(10) Pub. No.: US 2019/0328176 A1
(43) Pub. Date: Oct. 31, 2019

(54) BARBECUE WITH VERTICAL FIREBOXES AND WALLED COOKING ENCLOSURE

(71) Applicant: SMOW, Bresles (FR)

(72) Inventor: Nadir NECER, Pont-Sainte-Maxence (FR)

(73) Assignee: SMOW, Bresles (FR)

(21) Appl. No.: 16/395,771

(22) Filed: Apr. 26, 2019

(30) Foreign Application Priority Data
Apr. 27, 2018 (FR) 1853717

(51) Int. Cl. A47J 37/07

(52) U.S. Cl. CPC A47J 37/0718

(57) ABSTRACT

A barbecue including at least two vertical fireboxes, each configured to receive at least one heating means, and a cooking enclosure adapted to receive the food to be cooked, the cooking enclosure being disposed between the two vertical fireboxes, wherein the cooking enclosure includes at least two vertical, gas-tight heating lateral walls each disposed facing one of the two vertical fireboxes, configured so that the food inside the cooking enclosure is heated indirectly, the heating lateral walls respectively transmitting the heat generated by the heating means of the vertical fireboxes by radiation to the food from the two sides of the cooking enclosure.

### FIELD

The field of the invention is that of barbecues intended for cooking food.

### BACKGROUND

As is well known, a barbecue generally includes a horizontal firebox, the food being placed above the heat source or firebox. This kind of heat source usually includes one or more heating elements, such as incandescent wood charcoal for example, an electrical element or burned gas, or a combination of those various heating elements.

This kind of horizontal firebox barbecue generally has the disadvantage of allowing fat extracted from the food during cooking thereof to reach the cooking elements of the barbecue, which can generate a deposit of toxic, and in particular carcinogenic, materials, or the formation of flames that also risk spoiling the food. Also, this can also generate toxic fumes and smells that can be a nuisance in the environment of the barbecue.

In order to alleviate these disadvantages there is known for example from the document WO 2006/056703 A2 a barbecue of the vertical firebox type, i.e. with the heat source situated laterally with respect to the food: the cooking fluid such as fats and juice cannot drop onto the heating elements.

The document WO 2006/056703 A2 more particularly describes a barbecue with a double set of vertical fireboxes, adjustable in width, each having only one cooking face that is face to face with the food to be cooked, said sets of fireboxes including an insulated protective wall directly in contact with the fireboxes by circulation of air. Said vertical fireboxes constitute a source of heat and to this end receive one or more heating means.

The upper parts of the vertical fireboxes are extended by a plurality of demountable and articulated multipart reflective material flaps which when they are unfolded extend toward the opposite heating element so as to form a roof. Also, the fireboxes are connected at their ends by vertical demountable and articulated multipart reflective material flaps.

Vertical firebox type barbecues therefore have the following advantages:

they avoid the creation of flames given that fats do not flow into the firebox,

they reduce the risk of carbonization of meat.

Nevertheless, the inventor has noted that when the heat source is charcoal or wood this kind of barbecue still has the disadvantage that nothing isolates the food from the gases coming from the heating means present in the vertical fireboxes. The food is in direct contact with the smoke or the particles generated by these heating means.

Said flames, smoke or particles prove toxic for the food with which they come into contact, which represents a risk to the health of the consumer of this food, in particular given that the combustion of wood or of carbon releases polycyclic aromatic hydrocarbons which are potentially carcinogenic.

### SUMMARY

The invention proposes to alleviate this disadvantage by proposing a barbecue in which no smoke coming from the heating elements comes into contact with the food cooked by said barbecue, whilst guaranteeing optimum cooking of that food.

Other objects and advantages of the invention will become apparent in the course of the following description that is given by way of illustration only and is not intended to limit the invention.

Thus the invention concerns a barbecue including:

at least two vertical fireboxes, each configured to receive at least one heating means,

a cooking enclosure adapted to receive the food to be cooked, said cooking enclosure being disposed between the two vertical fireboxes.

According to the invention, said cooking enclosure includes at least two vertical, gas-tight heating lateral walls each disposed facing one of the two vertical fireboxes, configured so that the food inside the cooking enclosure is heated indirectly, said walls respectively transmitting the heat generated by the heating means of the vertical fireboxes by radiation to the food from the two sides of the cooking enclosure.

According to optional features of the invention, separately or in combination:

the heating lateral walls of said cooking enclosure are made of heat-resistant glass, for example glass ceramic or borosilicate glass;

said cooking enclosure is of substantially parallelepipedal shape including, in addition to the two heating lateral walls, a horizontal upper wall, or even a horizontal lower wall, a vertical front wall, and a vertical rear wall, said cooking enclosure being configured so as to confine the heat received via the two heating lateral walls;

the cooking enclosure includes:
a box formed by the upper wall, where applicable the lower wall, the rear wall, and the two heating lateral walls, with an access opening at the front,
a system for closing/opening said access opening at the front of the box, including said front wall of the cooking enclosure, which is removable from said box;

the walls of the box are held together by a frame structure including a plurality of interconnected angle irons retaining the upper wall, the rear wall, and the two heating lateral walls;

the barbecue further includes a food receiving support inside said box of the cooking enclosure, including retaining means configure to retain the food between the two heating lateral walls of said cooking enclosure, said food receiving support being a drawer element mounted to be mobile in translation in a horizontal direction in order to enable its withdrawal from/insertion in said box via the access opening of said box of the cooking enclosure;

the front wall of the system for closing/opening said access opening at the front of the box of the cooking enclosure is fastened to the food receiving support, or even forms an integral part of the structure of the food receiving support;

the system for closing/opening the cooking enclosure includes a handle fastened to the front wall;

said food receiving support includes a horizontal lower wall and a horizontal upper wall parallel to each other and a front wall, where appropriate constituted by the front wall of the system for closing/opening said access opening at the front of the box of the cooking enclosure, and a vertical rear wall, parallel to each other and connected by said lower wall and by said upper wall;

the food retaining means include a plurality of facing holes in each of the front wall and the rear wall of the food receiving support and/or a plurality of slots in the upper wall, opening laterally with respect to the upper wall;

each vertical firebox is conformed so as to form a receptacle for fuel, in particular wood charcoal, with a vertical heating lateral wall facing one of said heating lateral walls of said cooking enclosure, as well as a vertical combustion lateral wall opposite the heating wall and a horizontal lower wall, said receptacle being open at the top to provide the supply of fuel;

the heating lateral wall of a vertical firebox includes a plurality of first openings distributed with a density d1 and the combustion lateral wall of the vertical firebox disposed opposite the heating lateral wall includes a plurality of second openings distributed with a density d2 such that d2 is strictly less than d1;

the barbecue includes a support plate with a substantially plane upper face and raised edges projecting from said upper face, conformed so as to retain fuel residues, and the vertical fireboxes and the cooking enclosure are elements removably disposed on the upper face of said support plate;

a lift support is disposed on the support plate, said lift being configured to be greater than or equal to the height of the raised edges to guide movement in translation of the food receiving support relative to said box of the cooking enclosure and so that the food receiving support slides on top of the raised edges of said support plate;

the lengthwise dimension L of the plate is much greater than the sum of the thicknesses of the two fireboxes on the one hand and of the cooking enclosure resting on the upper face of the firebox on the other hand, and the fireboxes are configured to slide in the longitudinal direction of the plate, enabling increased intensity of heating inside said cooking enclosure by movement of each of the heating lateral walls of the fireboxes toward the corresponding two heating lateral walls of the cooking enclosure, or to the contrary to reduce the intensity of heating inside said cooking enclosure by moving each of the heating lateral walls of the fireboxes away from the corresponding heating lateral walls of the cooking enclosure.

### BRIEF DESCRIPTION OF THE DRAWINGS

The invention will be better understood on reading the following description accompanied by the appended figures, in which:

FIG. 1 is a perspective view of a barbecue according to one embodiment of the invention,

FIG. 2 is a perspective view of the barbecue from FIG. 1 in which the food receiving support is disposed outside the box of the cooking enclosure,

FIG. 3 is a detail view of the food receiving support from FIG. 1,

FIG. 4 is a view of FIG. 1 in section on a vertical plane perpendicular to the heating lateral walls,

FIG. 5 is a detail view of one of the two vertical fireboxes and of the box of the cooking enclosure, separate from the barbecue from FIG. 1,

FIG. 6 is a perspective view of the elements from FIG. 5 seen from a different angle.

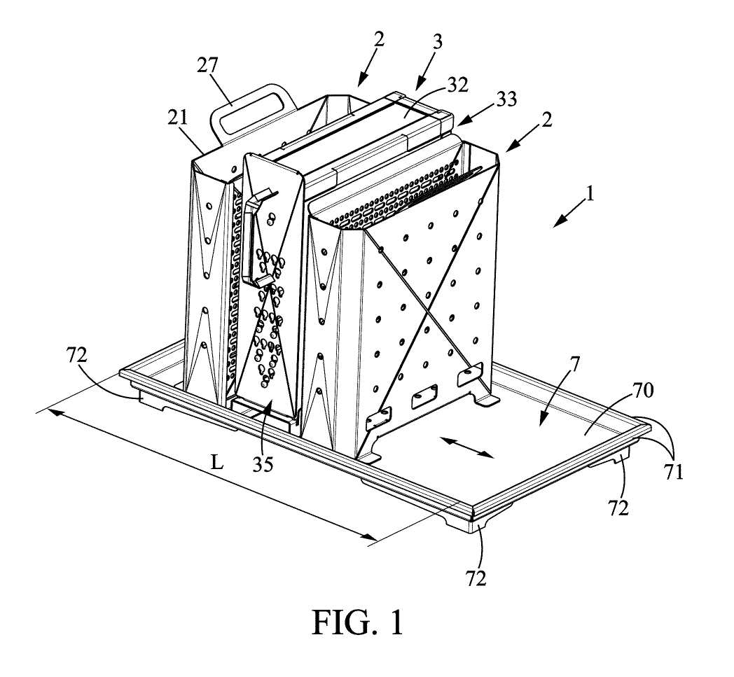

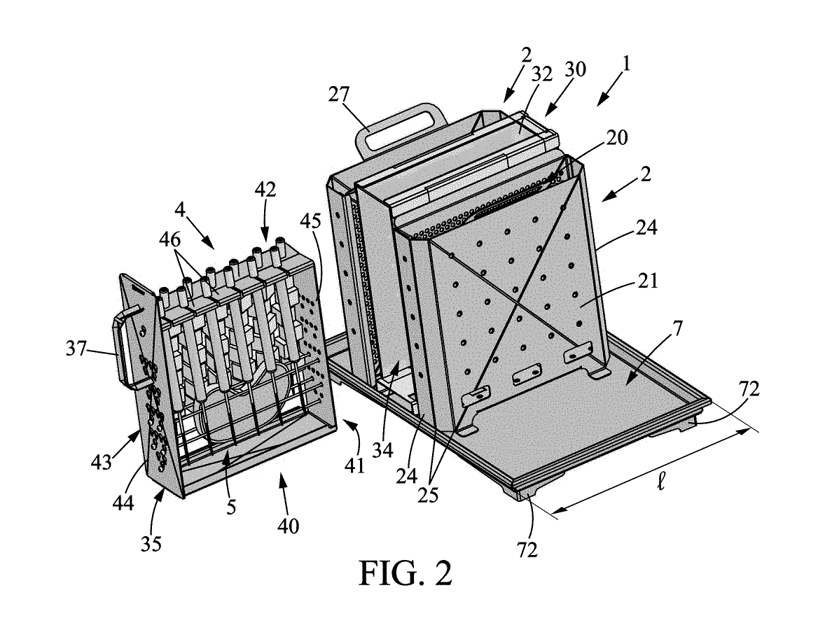

### DETAILED DESCRIPTION

The invention concerns a barbecue 1 including:

two parallel vertical fireboxes 2, each configured to receive at least one heating means,

a cooking enclosure 3 adapted to receive food 5 to be cooked, said cooking enclosure 3 being disposed between the two vertical fireboxes.

According to the invention, said cooking enclosure 3 includes at least two vertical heating lateral walls 31 that are impermeable to gases, each disposed facing one of the two vertical fireboxes 2, said heating lateral walls 31 being configured to heat the food 5 inside the cooking enclosure 3 by radiation of heat emitted by the two vertical fireboxes 2. The heating lateral walls may be parallel to one another in the case of two of them and according to one particular embodiment, when there are two fireboxes. According to an embodiment that is not shown, having the barbecue include a third firebox and even a fourth firebox may be envisaged.

The food 5 present in said cooking enclosure 3 is therefore protected by the heating lateral walls 31 from flames, smoke and particles generated by the heating means disposed in the vertical fireboxes, in particular when the heating means include incandescent charcoal or wood.

The food 5 inside the cooking enclosure, being disposed between these at least two heating walls 31, is heated indirectly, said heating lateral walls 31 respectively transmitting the heat generated by the heating means of the vertical fireboxes 2 by radiation (infrared radiation) to the food from both sides of the cooking enclosure.

According to one embodiment, the heating lateral walls 31 of said cooking enclosure 3 are made of heat-resistant glass, for example glass ceramic or borosilicate glass.

These kinds of heat-resistant glass are particularly advantageous in particular in that they will not deteriorate because of the large quantity of heat transmitted by the heating means of the vertical fireboxes 2 whilst optimally transmitting that heat by radiation to the food 5 positioned in said cooling enclosure 3, in order to cook it. They also have the advantage of having a low unit cost.

The borosilicate glass employed may advantageously be that marketed by the company PYREX®.

As can be seen in the embodiment from FIGS. 4 to 6, the thickness of said heating lateral walls 31 may be between 3 and 6 mm inclusive in order to guarantee good transmission of heat and some ruggedness of the cooking enclosure 3.

According to one embodiment, said cooking enclosure 3 is of substantially parallelepipedal shape including, in addition to the two heating lateral walls 31, a horizontal upper wall 32 and even a horizontal lower wall 38, a vertical front wall 35 and a vertical rear wall 33, said cooking enclosure 3 being configured so as to confine heat received via the two heating lateral walls 31. This kind of cooking enclosure, by confining the food, enables it to be heated rapidly and protects the food against wind that could delay its cooking.

Thanks to this advantageous disposition of the invention, heat escapes less easily from the cooking enclosure 3, which enables reduction of the energy demands of the barbecue to provide heat for cooking food, in particular the quantity of charcoal to place in the vertical fireboxes 2, and guarantees optimum cooking of the food 5 in the cooking enclosure 3.

According to one embodiment, the cooking enclosure 3 includes:

a box 30 formed by the upper wall 32, the lower wall 38, where applicable the rear wall 33 and the two heating lateral walls 31, with an access opening 34 at the front,

a system for closing/opening said access opening 34 at the front of the box 30, including said front wall 35 of the cooking enclosure 3 that can be removed from the box 30.

A handle 37 fastened to the front wall 35 extends outside the cooking enclosure 3 to facilitate placing that front wall 35 in a position in which it blocks the access opening while cooking, toward a position in which that front wall 35 is retracted, freeing the access opening 34.

According to one embodiment, the walls of the box are held together by a frame structure including a plurality of interconnected angle irons 36 retaining the upper wall 32, the rear wall 33 and the two heating lateral walls 31.

A first substantially horizontal upper angle iron 36 joins the upper wall 32 to one of the heating lateral walls (the left-hand one) and a horizontal second upper angle iron that is substantially parallel to the first angle iron joins the upper wall 32 to the other heating lateral wall 31 (the right-hand one).

A substantially vertical third angle iron 36 joins the (left-hand) lateral wall 31 to the rear wall 33 and a vertical fourth angle iron 36 joins the other (right-hand) lateral wall 31 to the rear wall 33.

On this subject, the rear wall 33 and/or the upper wall 32 may also be made of heat-resistant glass, for example glass ceramic or borosilicate glass.

The substantially horizontal upper wall 32 may serve as a cooking plate such as a grill-stone to finish the cooking of the food or to keep the food hot in a container placed on it.

In the lower part, the lateral walls 31 and even the rear wall 33 may also be retained at the bottom by angle irons (not shown).

Alternatively, the lower wall 38 of the cooking enclosure 3 may be made of metal and formed by a support 6 retaining the lower edges of the heating lateral walls 31, and even the rear wall 33.

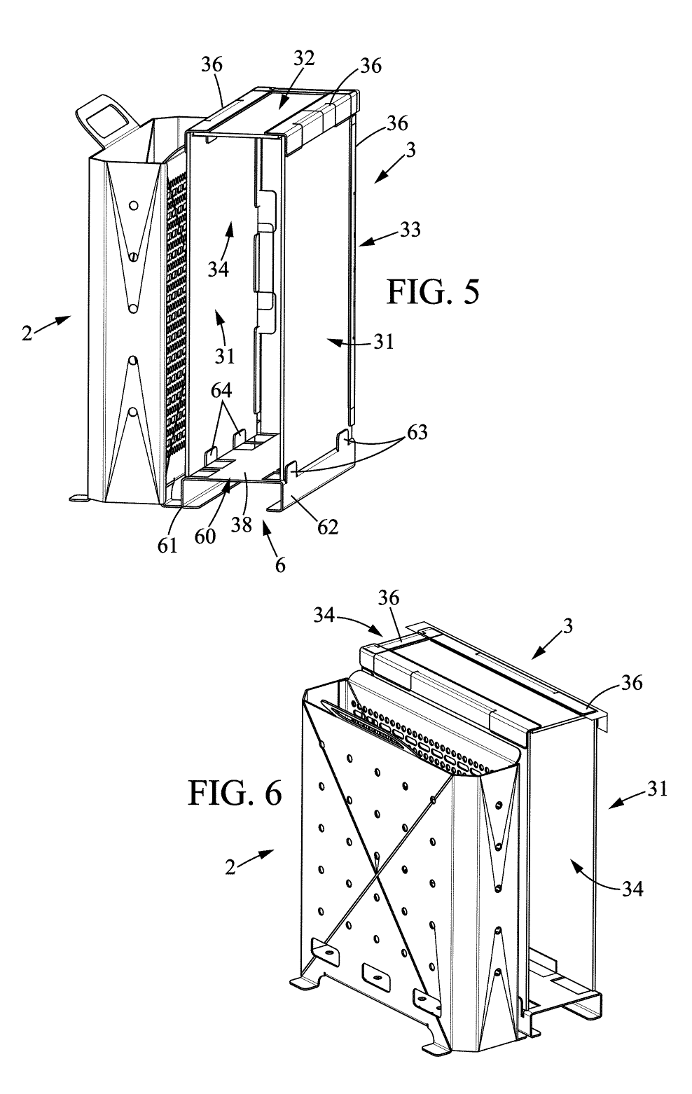

As shown in FIG. 5, this support 6 is formed from sheet metal precut and bent to form:

a stand 61, 62, projecting downward from the lower wall 38, intended to rest on a horizontal support, the stand raising the lower wall 38,

pairs of interior retaining flanges 64 and exterior retaining flanges 63 projecting upward from the lower wall 38 intended to retain the lower edge of the heating lateral walls 31 and even the lateral wall 33.

As shown in FIG. 5, the stand is obtained by bending the two longitudinal ends of the sheet metal in order to form the two stands 61, 62, the stands 61, 62 projecting downward from the same side of the lower wall 38. The retaining flanges 63, 64 are formed by cutting the sheet metal and bending it at substantially 90°, said retaining flanges 63, 64 projecting from the other side of the lower wall 38 relative to the stands 61, 62.

For each wall 31 or 33 to be retained, namely the left-hand (or right-hand) heating lateral wall 31, and even the rear wall 33, the interior flange 64 and exterior flange 63 of each pair are spaced by a distance corresponding to the thickness of the lateral wall to be retained. The flanges 63 and 64 retain the wall to be retained between said interior and exterior flanges of the same pair by virtue of insertion and nesting.

The barbecue may further include a support 4 for receiving food intended to be inside said box of the cooking enclosure. This receiving support 4 includes retaining means configured to retain food between the two heating lateral walls 31 of said heating enclosure.

The food receiving support 4 may be a drawer element, namely an element mounted to be mobile in translation in a horizontal direction in order to enable its withdrawal from/insertion into said box via the access opening 34 of said box of the cooking enclosure 3, essentially by sliding. This drawer element slides for example on the lower wall 38 of the box 30.

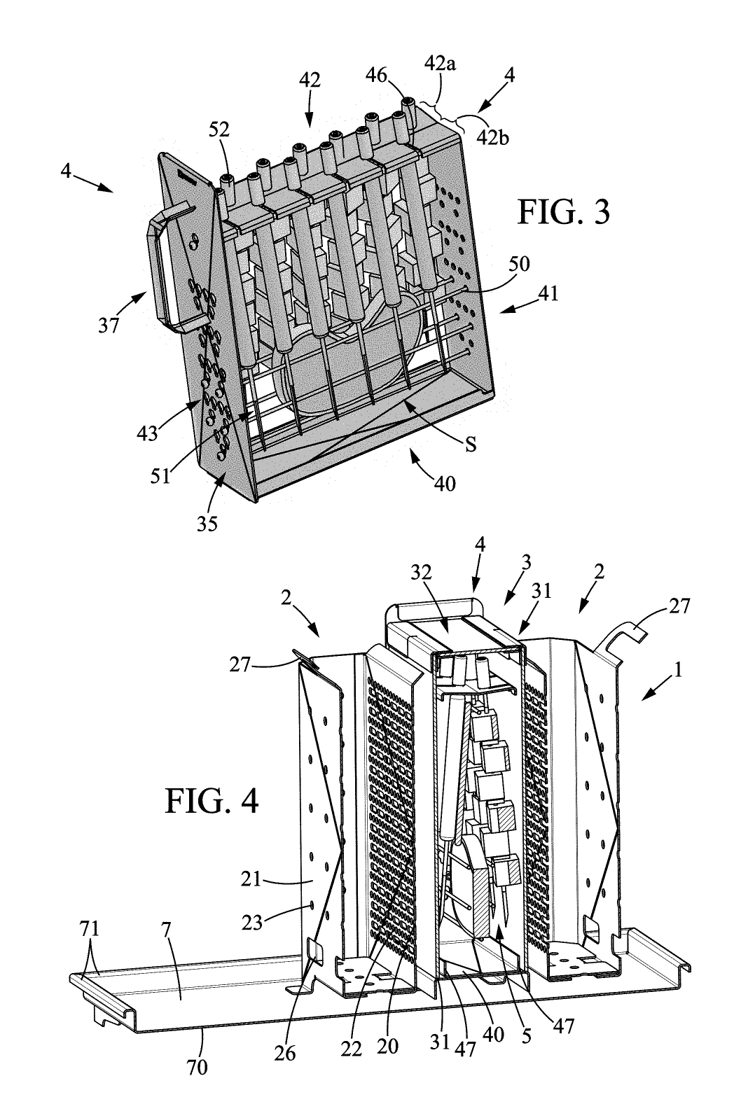

According to an embodiment shown here, the front wall 35 of the system for closing/opening said access opening at the front of the box of the cooking enclosure is advantageously fastened to the food receiving support 4, or even forms an integral part of said food receiving part support 4, as shown by way of illustration in FIG. 3.

This facilitates manual withdrawal and insertion operations: the food receiving support 4 and the front wall 35 are removed by sliding the combination outward (or inserted by sliding the assembly inside the box).

It is noted that said food receiving support 4 may include:

a horizontal lower wall 40 and a parallel horizontal upper wall 42, and

a front wall 43 (where appropriate consisting of the front wall 35 of the system for closing/opening said access opening at the front of the box of cooking enclosure), and a vertical rear wall 41.

The rear wall 41 and the front wall 43 are parallel to each other and connected by said lower wall 40 and by said upper wall 42.

The structure of the cooking support may therefore include:

a first precut metal sheet forming the front wall 43 of the support 4, constituted by the front wall 35 of the system for closing/opening said access opening at the front of the box,

a second precut metal sheet bent into a U shape and forming the upper wall 42, the rear wall 41 and the lower wall 40 of the support 4.

The two free ends of the second metal sheet bent into a U are fixed to the internal face of the first metal sheet forming the front wall 43.

It is further noted the presence of the food retaining means including a plurality of facing holes 44, 45 in each of the front wall 43 and the rear wall 41 of the food receiving support 4 and/or a plurality of slots 46 formed in the upper wall 42.

The food 5 may be supported by skewers 50, for example made of wood, substantially horizontal at this time, each of which is retained by threading the two ends of the skewer respectively into two facing holes 44 and 45 in the front wall 43 and the rear wall 45 respectively.

Alternatively, or additionally, a plurality of slots 46 may extend in the upper wall 42 of the support 4. Each slot 46 opens laterally of the upper wall 42. In particular substantially parallel first slots 46 may open laterally on one side of the upper wall 42 and second slots 46 disposed in a quincunx relative to the first slots may open on the other side of the upper wall 42. Each slot 46 enables suspension of a skewer 51, which is substantially vertical at this time. The skewer 51 is slid into the slot 46 in the upper wall 42 so that an enlarged upper part of the skewer (such as an end 52 for holding it) larger than the thickness of the slot continues to bear on the upper wall 42. The food spiked by the skewer is then substantially disposed between the upper wall 42 and the lower wall 40 of the support 4. The slots 46 may terminate in a round opening the diameter of which is greater than the width of the slot 46. The holding end piece may then include a lug, in particular a conical lug, coaxial with the skewer, intended to lock into the round opening. The upper wall 42 may be bent around a longitudinal axis to form around that axis two walls 42a and 42b of a V section inclined to each other. This longitudinal bend stiffens the upper wall 42 but above all inclines the slots 46 so that the skewers 51 are naturally loaded by gravity in the direction of the longitudinal bend. The longitudinal edges of the upper wall 42 may be curved in order to avoid the risk of cuts.

Generally speaking, the edges of the metal sheets may be rounded, in particular to increase stiffness and to eliminate sharp edges and thus the associated risk of cuts.

It is further noted that the lower wall 40 may form a tray for retaining cooking fluids such as fats and juice. To this end, the longitudinal edges of the sheet metal section forming the lower wall 40 are raised. These raised edges 47 form with the horizontal section of the lower wall 40 said retaining tray. The tray may be provided with a notch forming a pouring spout.

Each vertical firebox 2 may be conformed so as to form a receptacle for fuel, notably wood charcoal, with a vertical heating lateral wall 20 situated facing one of said heating lateral walls 31 of said cooking enclosure as well as a vertical combustion lateral wall 21 and a horizontal lower wall. Each vertical firebox 2 is preferably a removable element.

This receptacle is open at the top to provide for feeding fuel. The sheet metal forming the heating lateral wall 20 has first openings 22 to encourage the transmission of heat to the cooking enclosure 3. The combustion lateral wall 21 opposite the heating wall 20 is provided with second openings 23 to favour the entry of air and thus the combustion of the fuel inside the container. A handle 27 may be provided in the upper part of the receptacle in order to manipulate it, being for example fastened to the end of the combustion lateral wall 21.

The percentage of voids created by the first openings 22 in the heating lateral wall 20 is greater than the percentage of voids created by the second openings 23 in the combustion wall 21.

To this end, the density d1 of the first openings 22 may be higher than the density d2 of the second openings 23, as can be seen in FIG. 4.

Each combustion firebox 2 may be obtained by means of precut and bent refractory stainless sheets. Note that the plane combustion lateral wall 21 opposite the heating face 20 on the one hand and the lateral flanks 24, substantially at right angles to the combustion lateral wall 21 on the other hand are produced from the same sheet following two bends 25 at 45°.

Larger openings 26 for inserting firelighters are provided at the bottom of the combustion face 21.

According to one embodiment, the barbecue may include a support plate 7 with a substantially plane upper face 70 forming the back wall of the plate and raised edges 71 projecting from said upper face 70, conformed so as to retain fuel residues. The raised edges 71 extend continuously along four sides of the plate. The bottom of the plate may feature an opening closed by a removable plug. When the plug is removed, this opening enables evacuation of liquids such as rainwater trapped on the plate (not shown).

The plate may comprise projecting feet 72 on its lower surface. The plate may be made of stainless steel and be slightly flexible so that it is in equilibrium on these four feet even when the feet 72 are resting on a support that is not flat.

The support 6 has a lifting function and is disposed on the support plate 7, said lift being greater than or equal to the height of the rims to assure the guiding in translation of the food receiving support 4 relative to said box of the cooking enclosure: this ensures that the food receiving support 4 slides above the raised edges 71 of said support plate.

The two vertical fireboxes 2 and the cooking enclosure 3 are elements removably disposed on the upper face of said support plate 7.

It is further noted that:

the widthwise dimension 1 of the plate may substantially correspond to the lengthwise dimension of each of the two fireboxes 2 and the cooking enclosure 3, or be slightly greater than that dimension,

the lengthwise dimension L of the plate is much greater than the sum of the thicknesses of the two fireboxes, on the one hand, and of the cooking enclosure.

The fireboxes 2 are therefore able to slide in the longitudinal direction of the plate in order to move each of the heating lateral walls 20 of the two fireboxes 2 closer to the corresponding heating lateral walls 31 of the cooking enclosure 3 to increase the heating intensity or to the contrary to move away each of the heating lateral walls 20 of the corresponding heating lateral walls 31 of the cooking enclosure 3 to reduce the intensity of heating.

The free part of the plate 7 may serve to place utensils, flavourings, and also to receive the food support 4 during removal after cooking or when changing the food.

1. A barbecue including:
at least two vertical fireboxes, each configured to receive at least one heating means; and
a cooking enclosure adapted to receive the food to be cooked, said cooking enclosure being disposed between the two vertical fireboxes,
wherein said cooking enclosure includes at least two vertical, gas-tight heating lateral walls each disposed facing one of the two vertical fireboxes, configured so that the food inside the cooking enclosure is heated indirectly, said heating lateral walls respectively transmitting the heat generated by the heating means of the vertical fireboxes by radiation to the food from the two sides of the cooking enclosure.

2. The barbecue according to claim 1, wherein the heating lateral walls of said cooking enclosure are made of heat-resistant glass, for example vitroceramic glass or borosilicate glass.

3. The barbecue according to claim 1, wherein said cooking enclosure is of substantially parallelepipedal shape including, in addition to the two heating lateral walls, a horizontal upper wall, or even a horizontal lower wall, a vertical front wall, and a vertical rear wall, said cooking enclosure being configured so as to confine the heat received via the two heating lateral walls.

4. The barbecue according to claim 3, wherein the cooking enclosure includes:
a box formed by the upper wall, where applicable the lower wall, the rear wall, and the two heating lateral walls, with an access opening at the front; and
a system for closing/opening said access opening at the front of the box, including said front wall of the cooking enclosure, which is removable from said box.

5. The barbecue according to claim 4, wherein the walls of the box are held together by a frame structure including a plurality of interconnected angle irons retaining the upper wall, the rear wall, and the two heating lateral walls.

6. The barbecue according to claim 4, further including a food receiving support inside said box of the cooking enclosure, including retaining means configure to retain the food between the two heating lateral walls of said cooking enclosure, said food receiving support being a drawer element mounted to be mobile in translation in a horizontal direction in order to enable its withdrawal from/insertion in said box via the access opening of said box of the cooking enclosure.

7. The barbecue according to claim 6, wherein the front wall of the system for closing/opening said access opening at the front of the box of the cooking enclosure is fastened to the food receiving support, or even forms an integral part of the structure of the food receiving support.

8. The barbecue according to claim 7, wherein the system for closing/opening the cooking enclosure includes a handle fastened to the front wall.

9. The barbecue according to claim 6, wherein said food receiving support includes a horizontal lower wall and a horizontal upper wall parallel to each other and a front wall, where appropriate constituted by the front wall of the system for closing/opening said access opening at the front of the box of the cooking enclosure, and a vertical rear wall, parallel to each other and connected by said lower wall and by said upper wall.

10. The barbecue according to claim 9, wherein the food retaining means include a plurality of facing holes in each of the front wall and the rear wall of the food receiving support and/or a plurality of slots in the upper wall, opening laterally with respect to the upper wall.

11. The barbecue according to claim 1, wherein each vertical firebox is conformed so as to form a receptacle for fuel, in particular wood charcoal, with a vertical heating lateral wall situated face to face with one of said heating lateral walls of said cooking enclosure, as well as a vertical combustion lateral wall opposite the heating wall and a horizontal lower wall, said receptacle being open at the top to provide the supply of fuel.

12. The barbecue according to claim 11, wherein the heating lateral wall of a vertical firebox includes a plurality of first openings distributed with a density d1 and the combustion lateral wall of the vertical firebox disposed opposite the heating lateral wall includes a plurality of second openings distributed with a density d2 such that d2 is strictly less than d1.

13. The barbecue according to claim 6, including a support plate with a substantially plane upper face and raised edges projecting from said upper face, conformed so as to retain fuel residues, and in which the vertical fireboxes and the cooking enclosure are elements removably disposed on the upper face of said support plate.

14. The barbecue according to claim 13, wherein a lift support is disposed on the support plate, said lift being configured to be greater than or equal to the height of the raised edges to guide movement in translation of the food receiving support relative to said box of the cooking enclosure and so that the food receiving support slides on top of the raised edges of said support plate.

15. The barbecue according to claim 14, wherein the lengthwise dimension L of the plate is much greater than the sum of the thicknesses of the two fireboxes on the one hand and of the cooking enclosure resting on the upper face of the firebox on the other hand, and in which the fireboxes are configured to slide in the longitudinal direction of the plate, enabling increased intensity of heating inside said cooking enclosure by movement of each of the heating lateral walls of the fireboxes toward the corresponding two heating lateral walls of the cooking enclosure, or to the contrary to reduce the intensity of heating inside said cooking enclosure by moving away each of the heating lateral walls of the fireboxes from the corresponding heating lateral walls of the cooking enclosure.

16. The barbecue according to claim 1, including a support plate with a substantially plane upper face and raised edges projecting from said upper face, conformed so as to retain fuel residues, and in which the vertical fireboxes and the cooking enclosure are elements removably disposed on the upper face of said support plate.

17. The barbecue according to claim 16, wherein the lengthwise dimension L of the plate is much greater than the sum of the thicknesses of the two fireboxes on the one hand and of the cooking enclosure resting on the upper face of the firebox on the other hand, and in which the fireboxes are configured to slide in the longitudinal direction of the plate, enabling increased intensity of heating inside said cooking enclosure by movement of each of the heating lateral walls of the fireboxes toward the corresponding two heating lateral walls of the cooking enclosure, or to the contrary to reduce the intensity of heating inside said cooking enclosure by moving away each of the heating lateral walls of the fireboxes from the corresponding heating lateral walls of the cooking enclosure.
